(19) United States
(12) Patent Application Publication
(10) Pub. No.: US 2002/0033836 A1
(43) Pub. Date: Mar. 21, 2002

(54) Device and method for changing the orientation and configuration of a display of an electronic device

(76) Inventor: Scott R. Smith, Crystal Lake, IL (US)

Correspondence Address: Wallenstein & Wagner, Ltd., 53rd Floor, 311 S. Wacker Drive, Chicago, IL, 60606-6630, US

(21) Appl. No.: 09/875,797

(22) Filed: Jun. 6, 2001

Related U.S. Application Data
(60) Provisional application No. 60/209,678, filed on Jun. 6, 2000.

(51) Int. Cl. G09G 5/00

(52) U.S. Cl. 345/649; 345/619

(57) ABSTRACT

The present invention is a device and method for converting a display of a portable electronic device, such as a PDA-type device, from a first display orientation and/or configuration to a second orientation and/or configuration via a single action. The device provides a “one-touch” or single-action change in the orientation and/or configuration of the viewing area of the display via a hard key, a soft key, or an orientation sensing/switching device within the electronic device.

### RELATED APPLICATIONS

This application claims priority to U.S. Provisional Patent Application No. 60/209,678.

### TECHNICAL FIELD

The present invention generally relates to electronic devices having displays, and more particularly to a PDA (Personal Digital Assistant) or other handheld computer or communications device having a “one-touch” configurable display.

### BACKGROUND OF THE INVENTION

The growth of the computer and communications industries has caused the development of new computer and communications devices having greater functionality and capability. In particular, with the recent growth of the wireless data communication industry, PDAs (Personal Digital Assistants), handheld computers, cellular telephones having data capability, and other such portable devices have become quite popular.

As wireless data communication capabilities progress, many of these portable devices have proven to be limiting with respect to software, hardware, and mechanical functionality. For example, with the increasing need to view large amounts of data on a handheld device, many of these devices have insufficient display capabilities. Many cellular telephones and other wireless communications devices now provide wireless access to the Internet, but do not have large enough displays to effectively view large amounts of data transferred from Internet websites or Internet portals that are connected to servers for other networks or databases. In particular, handheld PCs and PDA-type devices that run database programs, such as spreadsheet programs, do not have the capability of displaying complete screens of these programs in a manner that is efficient and convenient for a portable or handheld electronic device.

It is therefore an object of the present invention to provide a device and method that is capable of easily changing the orientation and/or configuration of a display of an electronic device in response to a single action by a user of the device.

### SUMMARY OF THE INVENTION

The present invention is a device and method for converting a display of a portable electronic device, such as a PDA-type device, from a first display orientation and/or configuration to a second orientation and/or configuration. In a preferred embodiment, the device and method provides for a change in the orientation of a display viewing area from “portrait” orientation mode to “landscape” orientation mode. The device and method can be used to change the display back-and-forth between the two display modes. Alternatively, the device and method can be used to toggle through any number of display modes that offer various pixel configurations or display viewing area orientations. The device provides a “one-touch” change in the orientation and/or configuration of the display.

In a first preferred embodiment, the orientation of the viewing area of the display is converted from “portrait” to “landscape,” and vice-versa, by pressing a hard key, such as a button, on the electronic device.

In a second preferred embodiment, the orientation of the viewing area of the display is converted from “portrait” to “landscape,” and vice-versa, by pressing a soft key, such as an area displayed on a pressure or touch sensitive display.

In an alternate embodiment, the orientation and/or configuration of the viewing area of the display is automatically converted through an orientation sensing/switching device within the electronic device that senses the orientation of the electronic device with respect to a reference position.

### BRIEF DESCRIPTION OF THE DRAWINGS

FIG. 1 is a top plan view of a portable electronic device having a display in portrait mode, wherein the orientation of the display is depicted by horizontal lines.

FIG. 2 is a top plan view of a portable electronic device having a display in landscape mode, wherein the orientation of the display is depicted by vertical lines.

FIG. 3 is a top plan view of a portable electronic device having a display in a first mode, wherein the display has an adjustable display density to accommodate various display modes, such as portrait and landscape modes, via horizontal and vertical pixel count of the display.

FIG. 4 is a top plan view of the portable electronic device of FIG. 3 in a second display mode.

### DETAILED DESCRIPTION OF THE PREFERRED EMBODIMENTS

While the present invention will be described fully hereinafter with reference to the accompanying drawings, in which a particular embodiment is shown, it is to be understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

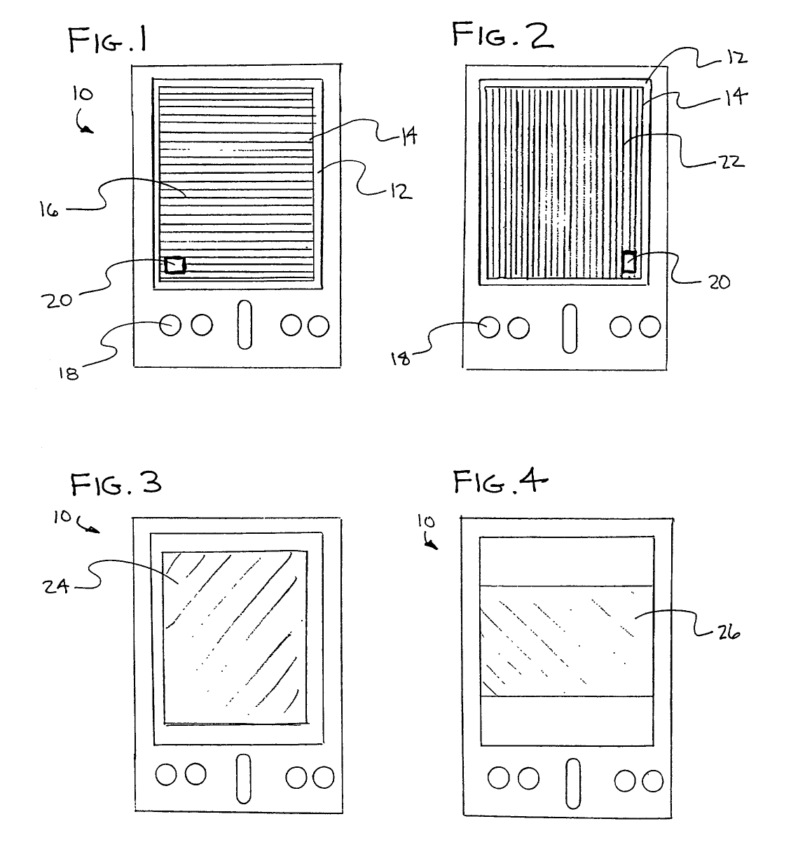

The present invention is a device and method for converting a viewing area of a display of a portable electronic device from a first display orientation and/or configuration to a second orientation and/or configuration. FIG. 1 depicts a portable electronic device 10 having a display 12 and a display viewing area 14. The viewing area 14 in FIG. 1 is in portrait mode. Horizontal lines 16 extend across the width of the display viewing area to indicate that the orientation of the display is in portrait mode. A number of hard keys 18 are provided on the device 10. One of the hard keys 18 can be programmed via a software program of the device, to change the orientation of the viewing area 14 of the display 12. Alternatively, a soft key 20 can be programmed to change the orientation of the viewing area 14 of the display 12. The soft key 20 appears as an icon or other graphic depiction, on the display 12. In this alternate embodiment, the display 12 is a pressure or touch sensitive display. Soft key 20 can be activated by a stylus (not shown) making contact with the display or by the touch of a user's finger.

When a user desires to view the display 12 in a second orientation mode, such as landscape mode, the user can press the appropriate key (i.e., the appropriate hard key 18 or the soft key 20, whichever is provided on the device 10). FIG. 2 depicts the electronic device 10 having the viewing area 14 in landscape mode. Vertical lines 22 extend across the height of the display viewing area 14 to indicate that the orientation of the display viewing area 14 is in landscape mode. In this particular configuration, the user would have to rotate the device 10 to properly view the display 12.

In an alternate embodiment, the orientation of the display viewing area 14 can be changed without the need for the user to rotate the device 10 to properly view the display 12 in the new orientation. In this embodiment, the appropriate software changes the vertical and horizontal pixel configuration and accommodates the new orientation in response to an activated key. FIG. 3 depicts the device 10 in a first display mode having a viewing area 24. In order to accommodate a second display mode having a viewing area 26, as depicted in FIG. 4, the appropriate software of the device changes the vertical and/or horizontal pixel count to a new configuration. In this embodiment, some of the effective viewing area may not be utilized in certain configurations.

In yet another alternate embodiment, the orientation of the viewing area 14 of the display 12 can be automatically changed from portrait to landscape, and viceversa, in response to an orientation sensing/switching device (not shown) within the device 10. The orientation sensing/switching device provides a switch that automatically activates in response to the orientation of the device 10 with respect to a reference orientation. The sensing/switching device can be any type known to one skilled in the art, such as a mercury switch or other liquid switch, a mechanical gravity switch, a combination moveable magnet and Hall effect switch, a combination moveable magnet and Reed switch, or equivalents thereof.

The method of the present invention is directed to a single-action method for re-configuring the orientation of the display. All of the embodiments of the present invention accommodate a “one-touch” method for re-configuring the orientation of the display. The method includes the step of activating a switch of an electronic device having a display with a viewing area, the activation of the switch causing the viewing area of the display to change from a first configuration to a second configuration.

It is to be understood that the device and method of the present invention is not limited to changing the display viewing area 14 from portrait mode to landscape mode. Any number of configuration and/or orientation modes can be provided. In such an embodiment, a user can toggle through a plurality of preset configurations by pressing the appropriately programmed key (one of the hard keys 18 or the soft key 20). Alternatively, the user can access a display software program to customize the display options available when the the appropriately programmed key is pressed.

It is also to be understood that the software required to facilitate the orientation and configuration changes described herein is within the ordinary skill of one in the software programming and electronic device arts.

It is also to be understood that the device and method of the present invention can be utilized an any electronic device having a display or screen and is not limited to portable electronic devices, such as PDAs.

What is claimed is:

1. A portable electronic device having a display with a viewing area for displaying indicia in a first orientation, the portable device comprising:
a processor operably connected to the display;
a memory operably connected to the processor;
a first code segment within the memory for generating the indicia in the first orientation within the viewing area;
a display orientation switch on a face of the portable electronic device, the switch operably connected to the processor, the switch providing a signal to the processor when the switch is toggled for switching the indicia from the first orientation within the viewing area to a second orientation in the viewing area.

2. The portable electronic device of claim 1 further comprising:
a second code segment within the memory for generating the indicia in the second orientation within the viewing area.

3. The portable electronic device of claim 1 wherein the first orientation is a portrait orientation.

4. The portable electronic device of claim 1 wherein the first orientation is a landscape orientation.

5. The portable electronic device of claim 1 wherein the second orientation is a portrait orientation.

6. The portable electronic device of claim 1 wherein the second orientation is a landscape orientation.

7. The portable electronic device of claim 1 wherein the switch is an icon displayed in the viewing area.

8. The portable electronic device of claim 1 further comprising:
a second code segment within the memory for generating the switch as a virtual representation.

9. The portable electronic device of claim 1 wherein the switch is a hard key.

10. The portable electronic device of claim 9 further comprising:
a second code segment within the memory for generating the indicia in the second orientation within the viewing area in response to receiving a signal that the hard key has been toggled.

11. The portable electronic device of claim 1 wherein the display is a touch sensitive display, and wherein the switch is activated by user touching a predetermined area on the display.

12. The portable electronic device of claim 1 wherein the first orientation and the second orientation are both viewable in an upright manner without rotating the portable electronic device, and wherein the second orientation uses less then the entire viewing area to display the second orientation.

13. A portable electronic device having a display with a viewing area for displaying indicia in a first orientation, the portable device comprising:
a processor operably connected to the display;
a memory operably connected to the processor;
a first code segment within the memory for generating the indicia in the first orientation within the viewing area;
a display orientation switch on a face of the portable electronic device, the switch operably connected to the processor, the switch providing a signal to the processor when the switch is toggled for switching the indicia from the first orientation within the viewing area to a second orientation in the viewing area, wherein the first orientation and the second orientation are both viewable in an upright manner without rotating the portable electronic device, and wherein the second orientation uses less then the entire viewing area to display the second orientation.

14. The portable electronic device of claim 13 further comprising:
a second code segment within the memory for generating the indicia in the second orientation within the viewing area.

15. The portable electronic device of claim 13 wherein the first orientation is a portrait orientation.

16. The portable electronic device of claim 13 wherein the first orientation is a landscape orientation.

17. The portable electronic device of claim 13 further comprising a second code segment within the memory for generating the switch as a virtual representation.

18. A portable electronic device having a display with a viewing area for displaying indicia in a first orientation, the portable device comprising:
a processor operably connected to the display;
a memory operably connected to the processor;
a first code segment within the memory for generating the indicia in the first orientation within the viewing area;
a automatic display orientation switch operably connected to the processor, the switch providing a signal to the processor when the switch is automatically toggled for automatically switching the indicia from the first orientation within the viewing area to a second orientation in the viewing area.

19. The portable electronic device of claim 18 wherein when the user rotates the portable electronic device, the automatic display orientation switch is toggled.

20. The portable electronic device of claim 18 wherein the automatic display orientation switch is a mercury switch.
